(19) United States
(12) Patent Application Publication
(10) Pub. No.: US 2015/0103204 A1
(43) Pub. Date: Apr. 16, 2015

(54) IMAGE PROCESSING DEVICE AND METHOD CAPABLE OF DISPLAYING HIGH-QUALITY IMAGE WHILE PREVENTING DISPLAY DELAY, AND IMAGE PICKUP APPARATUS

(71) Applicant: CANON KABUSHIKI KAISHA, Tokyo (JP)

(72) Inventor: Ryota Suzuki, Kawasaki-shi (JP)

(21) Appl. No.: 14/511,396

(22) Filed: Oct. 10, 2014

(30) Foreign Application Priority Data
Oct. 10, 2013 (JP) 2013-212741

(51) Int. Cl. H04N 5/232; H04N 5/907; H04N 1/21; H04N 5/262

(52) U.S. Cl. CPC H04N 5/23293; H04N 5/2628; H04N 5/907; H04N 1/212; H04N 2101/00
USPC 348/231.3

(57) ABSTRACT

An image processing device capable of preventing display delay and displaying an image with high quality while reducing processing load on the device. A simple developer generates a first developed image by developing a RAW image. A high-image quality developer generates a second developed image by developing the RAW image depending on load on the device. When an instruction for enlarged display of the first developed image is received, if there is stored the second developed image, a controller causes enlarged display of the second developed image to be performed. However, if no second developed image is stored, the controller causes a developed image for display use to be displayed, which is generated by developing part of the RAW image in a manner suited to enlarged display and has a higher image quality than the first developed image.

### BACKGROUND OF THE INVENTION

1. Field of the Invention

The present invention relates to an image processing device and method capable of displaying a high-quality image while preventing display delay, and an image pickup apparatus including the image processing device, and more particularly to an image processing device that processes a RAW image as a moving image or a still image.

2. Description of the Related Art

In general, the image processing device is provided in an image pickup apparatus, such as a digital still camera or a digital video camera. In the image pickup apparatus, imaging data acquired by an image pickup sensor, such as a CCD sensor or a CMOS sensor, is subjected to electronic development processing (noise elimination correction, gradation correction, sharpness correction, etc.) according to setting conditions set in advance, whereby electronically-developed imaging data is formed. In general, imaging data having been subjected to the electronic development processing (hereinafter referred to the “development processing”) is encoded by JPEG encoding processing, and is stored in a storage medium as a file.

By the way, when the developed imaging data (hereinafter simply referred to the “image data”) is encoded by the JPEG encoding processing, the number of color gradations is lost, since color information having a dynamic range of 10 to 12 bits for each of the colors of red (R), green (G), and blue (B) is converted to information having an equal dynamic range of 8 bits for each of the colors of red (R), green (G), and blue (B). Therefore, once the JPEG encoding processing is performed, it is difficult to perform the fine adjustment of image quality intended by a user, when editing.

To make it possible to perform fine adjustment of image quality intended by a user, in recent years, there has been known an image pickup apparatus that stores imaging data which has just been acquired by an image pickup sensor and has not been developed, in a storage medium as it is or after it is subjected to reversible compression. In general, the undeveloped imaging data is called RAW image data, and by recoding the RAW image data in a recording medium or the like, it is possible to perform fine-grained development or editing of the RAW image data as intended by the user, after photographing.

For example, there has been disclosed an image pickup apparatus that records, when recording RAW image data, a development parameter together with the RAW image data, and develops and reproduces, when reproducing an image, the RAW image data using the development parameter (see Japanese Patent Laid-Open Publication No. 2011-244423).

On the other hand, there has been disclosed an image pickup apparatus that generates low-resolution JPEG image data e.g. when recording the RAW image data, to reduce display delay of an image corresponding to RAW image data (see Japanese Patent Laid-Open Publication No. 2006-229474). In this image pickup apparatus, the low-resolution JPEG image data is used as a display image to reduce display delay.

Further, there has been disclosed an image pickup apparatus that reduces display delay by generating reduced RAW image data as image data for display when recording RAW image data to thereby suppress load in development processing (see Japanese Patent Laid-Open Publication No. 2012-95351).

As described above, in the image pickup apparatus disclosed in Japanese Patent Laid-Open Publication No. 2011-244423, during photographing, the RAW image data is directly recorded without being developed, and hence the amount of development processing during photographing is reduced. However, in this image pickup apparatus, it is difficult to quickly reproduce and display the image during reproduction processing since the RAW image data is recorded.

In other words, in the image pickup apparatus disclosed in Japanese Patent Laid-Open Publication No. 2011-244423, to enhance photographing performance and also display the reproduced image at high speed, it is required that an expensive processing circuit is mounted on the image pickup apparatus or that the RAW image data is made capable of being quickly and easily reproduced.

On the other hand, as described above, in the image pickup apparatus disclosed in Japanese Patent Laid-Open Publication No. 2006-229474 or Japanese Patent Laid-Open Publication No. 2012-95351, the low-resolution JPEG image data or compressed RAW image data is used as display image data so as to reduce display delay. However, when the user desires to check details of photographing results, such as a focusing state, if the low-resolution JPEG image data is used as display image data, it is difficult to check the details.

### SUMMARY OF THE INVENTION

The present invention provides an image processing device and method capable of preventing display delay and displaying an image with high quality while reducing processing load on the image processing device, and an image pickup apparatus including the image processing device.

In a first aspect of the present invention, there is provided an image processing device comprising a display unit configured to display an image, a first generation unit configured to generate a first developed image by developing a RAW image, a second generation unit configured to generate a second developed image having a higher image quality than the first developed image by developing the RAW image depending on load on the image processing device, a storage unit configured to be capable of storing the RAW image and the first and second developed images, and a display control unit configured to control image display by the display unit, wherein in a case where an instruction for enlarged display of the first developed image displayed on the display unit has been received, if the second developed image is stored in the storage unit, the display control unit performs enlarged display of the second developed image, whereas if the second developed image is not stored in the storage unit, the display control unit displays a developed image for display use which is generated by developing part of the RAW image in a manner suited to enlarged display and has a higher image quality than the first developed image.

In a second aspect of the present invention, there is provided an image pickup apparatus comprising an image pickup unit configured to pick up an image, and an image processing device, wherein the image processing device comprises a display unit configured to display an image, a first generation unit configured to generate a first developed image by developing a RAW image, a second generation unit configured to generate a second developed image having a higher image quality than the first developed image by developing the RAW image depending on load on the image processing device, a storage unit configured to be capable of storing the RAW image and the first and second developed images, and a display control unit configured to control image display by the display unit, wherein in a case where an instruction for enlarged display of the first developed image displayed on the display unit has been received, if the second developed image is stored in the storage unit, the display control unit performs enlarged display of the second developed image, whereas if the second developed image is not stored in the storage unit, the display control unit displays a developed image for display use which is generated by developing part of the RAW image in a manner suited to enlarged display and has a higher image quality than the first developed image.

In a third aspect of the present invention, there is provided an image processing method, comprising generating a first developed image by developing a RAW image, generating a second developed image having a higher image quality than the first developed image by developing the RAW image depending on load on an image processing device, storing the RAW image and the first and second developed images, performing enlarged display of the second developed image, in a case where an instruction for enlarged display of the first developed image displayed on the display unit has been received, if the second developed image is stored in the storage unit, and displaying a developed image for display use which is generated by developing part of the RAW image in a manner suited to enlarged display and has a higher image quality than the first developed image, in the case where the instruction for enlarged display of the first developed image displayed on the display unit has been received, if the second developed image is not stored in the storage unit.

According to the present invention, it is possible to prevent display delay and, what is more, display the image with high quality, while reducing processing load on the image processing device, since first image data, second image data, and third image data are selectively displayed on a display section according to an instruction for displaying the image.

Further features of the present invention will become apparent from the following description of exemplary embodiments (with reference to the attached drawings).

### BRIEF DESCRIPTION OF THE DRAWINGS

FIG. 1 is a block diagram of a digital camera as an image pickup apparatus including an image processing device according to a first embodiment of the present invention.

FIG. 2 is a flowchart of a photographing mode-time process performed by the digital camera shown in FIG. 1.

FIGS. 3A and 3B are diagrams useful in explaining a still image file and a RAW file generated by the digital camera, in which FIG. 3A shows the structure of the still image file, and FIG. 3B shows the structure of the RAW file.

FIG. 4 is a flowchart of an idle state-time process performed by the digital camera in an idle state in which photographing is not performed.

FIG. 5 is a flowchart of a still image reproduction mode-time process performed by the digital camera.

FIGS. 6A to 6C are diagrams useful in explaining an example of a display process in the still image reproduction mode-time process performed by the digital camera, in which FIG. 6A shows an example of reduction display (thumbnail display), FIG. 6B shows a state in which one of thumbnail images shown in FIG. 6A is displayed on a whole display section, and FIG. 6C is an enlarged view of part of the image shown in FIG. 6B.

FIG. 7A is a flowchart of a still image reproduction mode-time process performed by a digital camera as an image pickup apparatus including an image processing device according to a second embodiment of the present invention.

FIG. 7B is a continuation of FIG. 7A.

### DESCRIPTION OF THE EMBODIMENTS

The present invention will now be described in detail below with reference to the accompanying drawings showing embodiments thereof.

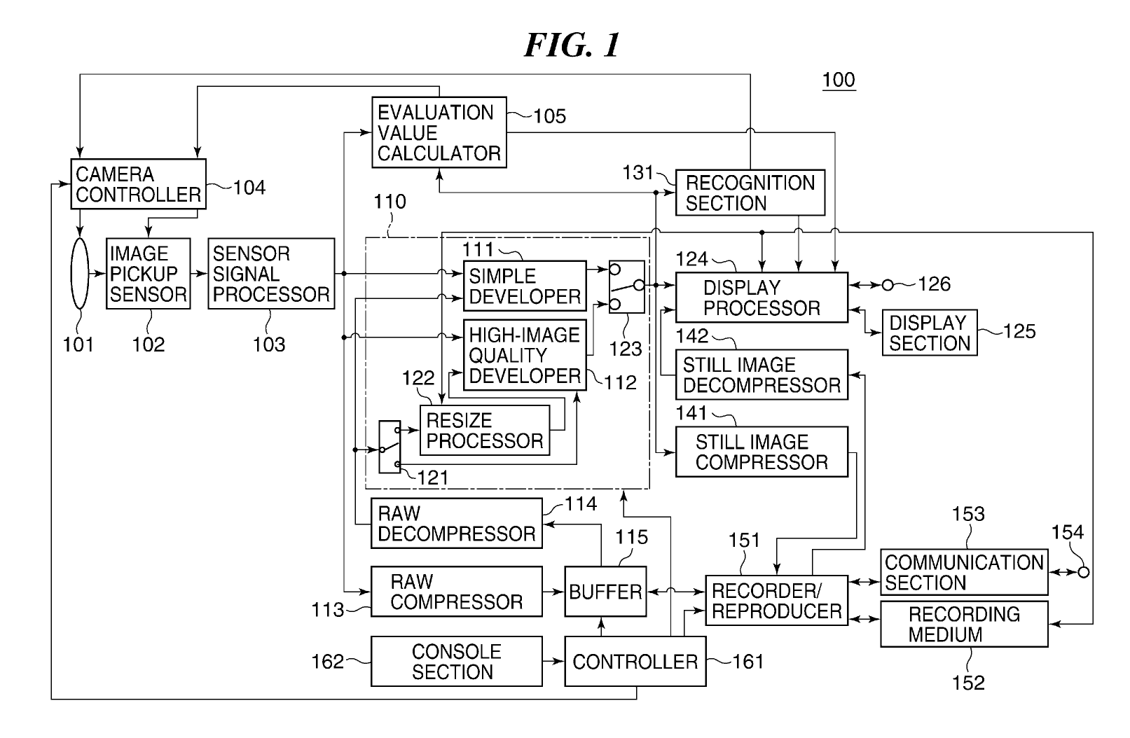

FIG. 1 is a block diagram of an image pickup apparatus including an image processing device according to a first embodiment of the present invention.

The image pickup apparatus 100 shown in FIG. 1 is e.g. a digital camera (hereinafter simply referred to as “the camera”), and records image data acquired by photographing an object, on a recording medium. Further, the camera 100 reads image data recorded in the recording medium, performs development processing on the image data, and then displays the image data as a reproduced image. Further, the camera 100 has a function of transmitting and receiving image data to and from an external apparatus, a server (cloud), and so forth.

The camera 100 is equipped with a controller 161. The controller 161 includes a CPU, not shown, and a memory, not shown, for storing control programs executed by the CPU. The controller 161 controls the overall operation of the camera 100.

A console section 162 is used by a user in giving various instructions to the controller 161, and includes input devices, such as keys, buttons, and a touch panel. An operation signal delivered from the console section 162 according to a user's operation is detected by the controller 161. The controller 161 executes control according to the operation signal.

A display section 125 includes e.g. a liquid crystal display (LCD). An image based on image data acquired by photographing or reproduction is displayed on the display section 125. Further, a menu screen and various information are displayed on the display section 125.

When an instruction for starting a photographing operation is given using the console section 162, the controller 161 causes a camera controller 104 to control an image pickup optical section 101 and an image pickup sensor 102, to thereby cause an optical image of an object as a photographing target to be formed on the image pickup sensor 102 via the image pickup optical section 101. During photographing of the object, the camera controller 104 controls the image pickup optical section 101 and the image pickup sensor 102 based on evaluation values concerning aperture stopping down, focusing, and camera shake, which are acquired by an evaluation value calculator 105, described hereinafter, and object information acquired by a recognition section 131.

The image pickup sensor 102 has color filters of red, green, and blue (RGB) arranged on respective associated ones of pixels. The image pickup sensor 102 delivers electric signals (analog signals) dependent on an optical image having passed through the color filters. The color filters in the image pickup sensor 102 are arranged e.g. in a Bayer array.

In the Bayer array, red (R), green (G), and blue (B) are arranged in a mosaic form on associated ones of pixels, and four pixels of two by two are regularly arranged in a manner such that one pixel of red, one pixel of blue and two pixels of green form one set.

The analog signals output from the image pickup sensor 102 are given to a sensor signal processor 103. The sensor signal processor 103 acquires digital signals by analog-to-digital conversion of the analog signals, and then performs pixel restoration. In this processing, processing for interpolating a pixel to be restored, using pixel values of pixels therearound, is performed on pixel values of missing pixels or pixels low in reliability of the image pickup sensor 102. Further, in the restoration processing, subtraction processing for subtracting a predetermined offset value from the digital signals is performed. In the illustrated example, digital signals delivered from the sensor signal processor 103 are called RAW image data which means undeveloped image data.

The RAW image data output from the sensor signal processor 103 is given to a development section 110, and is subjected to development thereby. The development section 110 includes a simple developer 111, a high-image quality developer 112, a resize processor 122, and switch sections 121 and 123. The simple developer 111 performs development processing on the RAW image data (or a decompressed RAW file, referred to hereinafter), and outputs first image data. The high-image quality developer 112 performs development processing on the RAW image data (or the decompressed RAW file, referred to, or an output from the resize processor 122), and outputs second or third image data, described hereinafter. Then, the first image data, and the second or third image data are transmitted to the switch section 123. The switch section 123 selects one of the first image data, and the second or third image data, as described hereinafter, and outputs the selected image data as developed image data.

The switch section 121 receives an output from a RAW decompressor 114, referred to hereinafter, and selectively gives the output to the resize processor 122 or the high-image quality developer 112. The resize processor 122 performs resize processing on the output from the RAW decompressor 114, and gives the resulting data to the high-image quality developer 112 as resized image data.

Note that the above-mentioned second image data is generated by the high-image quality developer 112 based on the RAW image data or the output from the RAW decompressor 114, and the above-mentioned third image data is generated by the high-image quality developer 112 based on the output from the resize processor 122. The controller 161 performs control for switching the switch section 121, according to a user's operation of the console section 162 or an operation mode, as will be described hereinafter.

The resize processor 122 generates RAW image data of a size suitable for image display (resized RAW image data) according to the number of pixels of the display section 125, before the start of the development processing. Here, the term of the “resize processing” refers to processing for resizing image data by known processing, such as pixel interpolation or pixel thinning.

Each of the simple developer 111 and the high-image quality developer 112 performs de-Bayer processing (de-mosaic processing) on RAW image data, to thereby convert the RAW image data to image data formed of a luminance component and a chrominance component. Further, each of the simple developer 111 and the high-image quality developer 112 eliminates noise contained in the image data, and performs so-called development processing for correcting optical distortion.

In the illustrated example, the high-image quality developer 112 acquires higher-quality image data (developed image) by performing the development processing with more accuracy than the simple developer 111 performs. On the other hand, highly-accurate development processing inevitably increases processing load, and hence the high-image quality developer 112 does not perform real-time development processing in parallel with photographing, but performs the development processing by distributed processing after photographing. As described above, by performing development processing after photographing instead of performing development processing in parallel with photographing, it is possible to suppress an increase in the circuit size and an increase in (the peak of) power consumption of the high-image quality developer 112.

The simple developer 111 processes image data which is lower in image quality than that of image data processed by the high-image quality developer 112, and hence the amount of processing required to be performed by the simple developer 111 is smaller than that required to be performed by the high-image quality developer 112. Therefore, the simple developer 111 is capable of performing development processing at higher speed during photographing. That is, since processing load on the simple developer 111 is smaller, it is possible to perform development processing in real time in parallel with photographing.

The controller 161 performs control for switching the switch section 123, according to a user's operation via the console section 162 or an operation mode. Note that although in the example illustrated in FIG. 1, the simple developer 111 and the high-image quality developer 112 exist in the development section 110 independently of each other, a single development section may be used to perform simple development processing and high-image quality development processing in a mutually exclusive manner according to an operation mode.

Image data output from the development section 110 (i.e. developed image data output from the switch section 123) is given to a display processor 124. The display processor 124 performs predetermined display processing on the developed image data, for display on the display section 125. Further, the developed image data may be output from a video output terminal 126 to an external display device via the display processor 124. The video output terminal 126 includes a general-purpose interface, such as an HDMI (registered trademark) or an SDI.

As shown in FIG. 1, the developed image data is also given to the evaluation value calculator 105. The evaluation value calculator 105 calculates evaluation values indicating a focus condition and an exposure condition based on the developed image data.

Further, the developed image data is also given to the recognition section 131. The recognition section 131 detects and recognizes an object based on the developed image data, and outputs object information indicative of the object. For example, the recognition section 131 detects a face area of a person as the object, from the developed image data. Upon detection of the face area, the recognition section 131 outputs object information indicative of a position of the face area in the image. Further, the recognition section 131 performs recognition (identification) of a specific person based on feature information indicating a feature of the face area.

In addition, the developed image data is also given to a still image compressor 141. The still image compressor 141 performs high-efficiency encoding (compressing encoding) on the developed image data to generate image data with a compressed amount of information, and converts the image data to a still image file. JPEG encoding, for example, is used for still image compression.

The RAW compressor 113 performs high-efficiency encoding on the RAW image data output from the sensor signal processor 103, using e.g. wavelet transform or differential encoding, to thereby converts the RAW image data to a compressed RAW file. Then, the RAW compressor 113 stores the compressed RAW file in a buffer (recording medium) 115.

Note that although the RAW file can be read from a state remaining in the buffer 115, the RAW file may be stored in the buffer 115 and then be moved to another recording medium (in this case, the RAW file is deleted from the buffer 115).

A recorder/reproducer 151 records the RAW file and the still image file on a recording medium 152. A large-capacity memory, a hard disk, or a memory card, for example, is used as the recording medium 152. The recorder/reproducer 151 reads out the still image file and the RAW file from the recording medium 152, and outputs them to a still image decompressor 142 or the buffer 115.

Further, the recorder/reproducer 151 writes various image files in an external storage or an external server via a communication section 153, and further reads the various image files from the external storage or the external server. The communication section 153 is capable of accessing the Internet or an external apparatus via wireless communication or wired communication using a communication terminal 154.

When a reproduction operation is started, the recorder/reproducer 151 acquires a desired image file from the recording medium 152 or via the communication section 153, and reproduces the image file. If the image file to be reproduced is a RAW file, the recorder/reproducer 151 stores the RAW file in the buffer 115, whereas if the image file to be reproduced is a still image file, the recorder/reproducer 151 sends the still image file to the still image decompressor 142.

The RAW decompressor 114 reads the RAW file stored in the buffer 115, and decodes and decompresses the RAW file in the compressed state. The RAW file subjected to decompression processing by the RAW decompressor 114 (decompressed RAW file) is sent to the simple developer 111 and the high-image quality developer 112.

Upon receipt of the still image file, the still image decompressor 142 decodes and decompresses the still image file, and sends the same to the display processor 124 as a reproduced image of the still image.

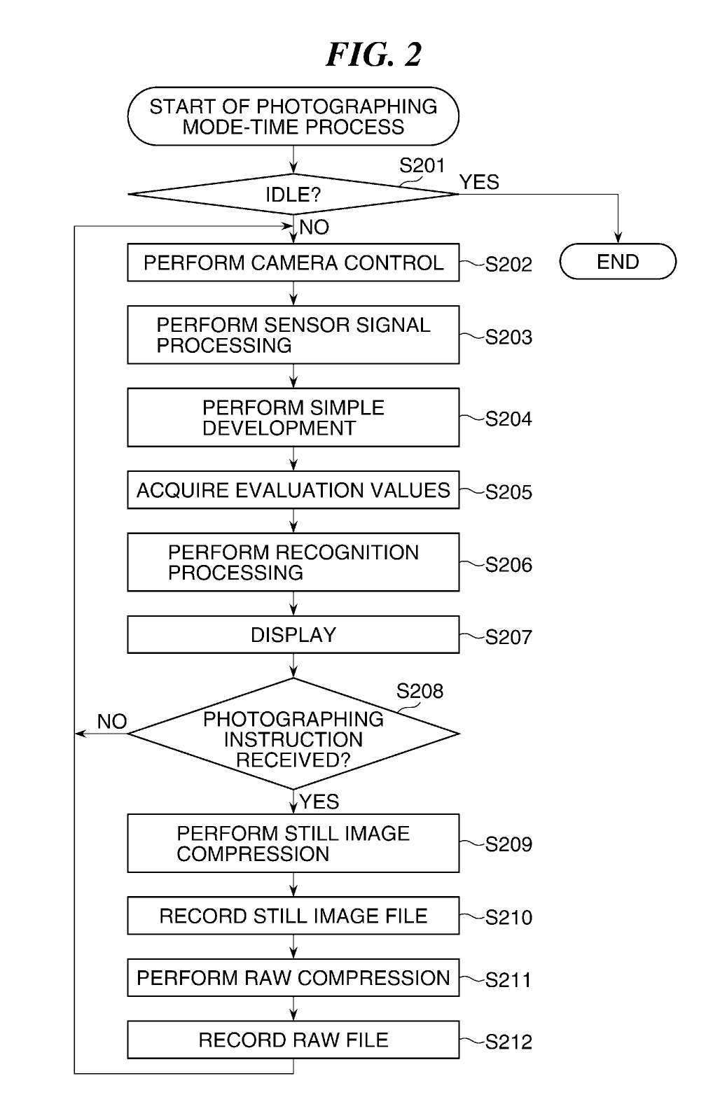

FIG. 2 is a flowchart of a photographing mode-time process performed by the camera shown in FIG. 1. Note that the illustrated photographing mode-time process is executed under the control of the controller 161. More specifically, a program stored in a ROM (included in the aforementioned memory) is loaded into a RAM (included in the aforementioned memory), and the CPU executes the loaded program.

When the photographing mode-time process is started, the controller 161 determines whether or not the processing load of the camera 100 is low, that is, whether or not the camera 100 is in an idle state (step S201). If the camera 100 is in the idle state (YES to the step S201), the controller 161 terminates the photographing mode-time process, whereas if the processing load of the camera 100 is high (e.g. during high-speed consecutive photographing), that is, the camera 100 is not in the idle state, in other words, if the camera 100 is in the photographing mode (NO to the step S201), the camera controller 104 under the control of the controller 161 controls the image pickup optical section 101 and the image pickup sensor 102, in order to perform photographing under predetermined photographing conditions (step S202).

For example, the camera controller 104 causes a zoom lens or a focus lens provided in the image pickup optical section 101 to move along the optical axis, according to a zooming instruction given by the user or a focusing instruction. Further, the camera controller 104 sets a reading area of the image pickup sensor 102 according to an instruction on the number of photographic pixels. In addition, the camera controller 104 performs focus adjustment and tracking control of a specific object based on evaluation values given by the evaluation value calculator 105 and object information given by the recognition section 131.

Next, the sensor signal processor 103 performs signal processing pixel restoration on the output (sensor signals) from the image pickup sensor 102 (step S203). In the signal processing, the sensor signal processor 103 performs processing for interpolating a pixel to be restored, using pixel values of pixels therearound, on pixel values of missing pixels or pixels low in reliability, and also performs subtraction processing for subtracting a predetermined offset value from the digital signals, as described hereinabove.

Next, the simple developer 111 performs development processing on the RAW image data output from the sensor signal processor 103 (step S204: simple development). At this time, the controller 161 performs switching control of the switch section 123 to thereby select first image data output from the simple developer 111.

Note that as described hereinabove, the simple developer 111 performs de-Bayer processing (de-mosaic processing) on the RAW image data to thereby convert the RAW image data to image data formed of a luminance component and a chrominance component. Further, the simple developer 111 performs development processing for eliminating noise contained in the image data and correcting optical distortion.

Here, a description will be given of development processing (simple development) performed by the simple developer 111.

The simple developer 111 performs simple processing for performing high-speed development processing by limiting an image size of developed image data (e.g. by performing reduction processing) and limiting processing to elimination of noise and correction of optical distortion. Thus, the simple developer 111 reduces the image size and thereafter performs processing by partially limiting the development functions. This makes it possible to reduce not only the circuit size of the simple developer 111 but also power consumption thereby.

The first image data output from the simple developer 111 is sent to the evaluation value calculator 105. The evaluation value calculator 105 calculates evaluation values indicating a focus condition and an exposure condition based on luminance values and contrast values of the first image data (step S205). Note that the evaluation value calculator 105 may acquire RAW image data before being developed, and calculate the evaluation values based on the RAW image data.

Further, the first image data output from the simple developer 111 is sent to the recognition section 131. The recognition section 131 detects an object (face area, etc.) from the first image data, and acquires object information. For example, the recognition section 131 performs recognition processing on the first image data to determine whether a face area of a person as an object exists and a position of the face area, if any, and recognize (identify) a specific person, thereby outputting results of the recognition as object information (step S206).

Furthermore, the first image data output from the simple developer 111 is sent to the display processor 124. The display processor 124 generates a display image based on the first image data, and outputs the display image to the display section 125 or the external display device (step S207: display). The display image displayed on the display section 125 is used for live view display (though image display) for enabling the user to properly frame an object in the photographing mode.

Note that the display image may be sent from the display processor 124 to another display device, such as an external television, via the video output terminal 126, and be displayed on the other display device. Further, the display processor 124 may use the evaluation values and the object information sent from the evaluation value calculator 105 and the recognition section 131 to thereby cause e.g. a mark to be displayed in an in-focus area of the display image, and display a frame indicating a location of the recognized face area.

Then, the controller 161 determines whether or not a photographing instruction is given by a user's operation (step S208). If a predetermined time period has elapsed without receiving a photographing instruction (NO to the step S208), the controller 161 returns to the step S202 to perform control of the camera controller 104. On the other hand, if a photographing instruction is given (YES to the step S208), the first image data output from the simple developer 111 is sent to the still image compressor 141 under the control of the controller 161. Then, the still image compressor 141 performs high-efficiency encoding processing (still image compression) on the first image data and generates a still image file (step S209). The still image compressor 141 performs compression using a known still image compression method, such as JPEG encoding.

Then, the recorder/reproducer 151 records the above-mentioned still image file on the recording medium 152 (step S210). The RAW compressor 113 acquires RAW image data associated with the still image file, and generate a RAW file by performing high-efficiency encoding (RAW compression) on the RAW image data (step S211). This RAW file is stored in the buffer 115 by the RAW compressor 113 (step S212). After that, the controller 161 returns to the step S202 to perform control of the camera controller 104.

Note that the RAW compressor 113a performs the high-efficiency encoding by a well-known encoding method, such as wavelet transform or differential encoding. Encoding processing performed here may be either irreversible compression encoding processing or reversible compression encoding processing. Further, the RAW compression performed by the RAW compressor 113 may be omitted, and the RAW image data may be recoded on the buffer 115 in an uncompressed state. That is, irrespective of whether or not the RAW compression is performed, in the step S211, the RAW image data is stored in the buffer as a high-quality file in which integrity of the RAW image data is not lost.

In the above-mentioned steps S210 and S212, the recorder/reproducer 151 may send the still image file and the RAW file from the communication terminal 154 to the external storage via the communication section 153.

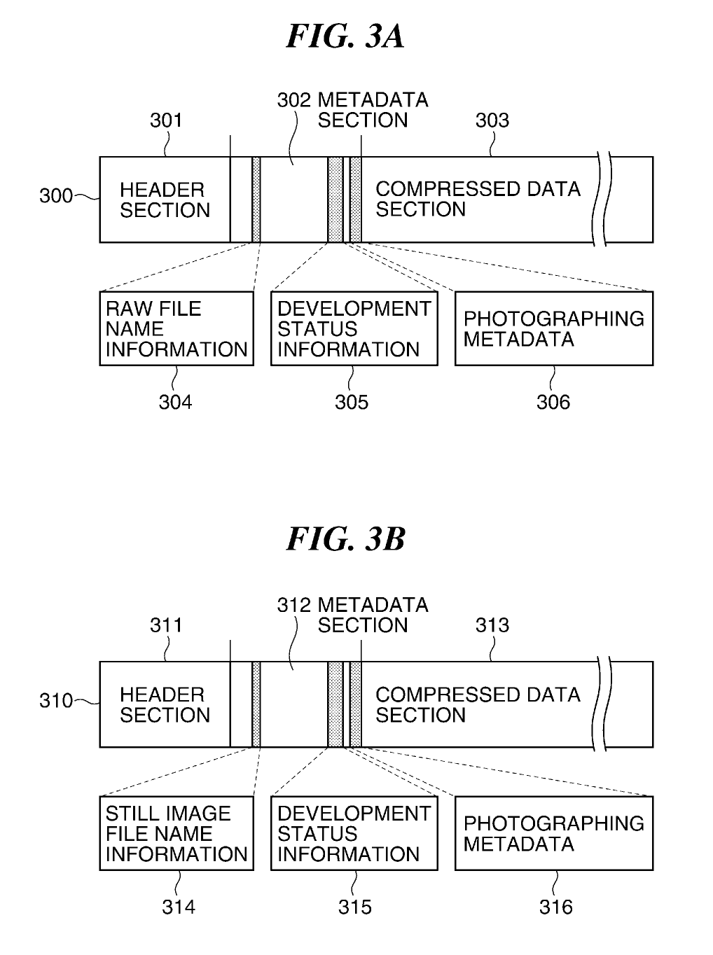

FIGS. 3A and 3B are diagrams useful in explaining the still image file and the RAW file generated by the camera shown in FIG. 1, in which FIG. 3A shows the structure of the still image file, and FIG. 3B shows the structure of the RAW file.

First, referring to FIG. 3A, the still image file 300 will be described. The still image file 300 is recorded in a predetermined recording area of the recording medium 152 by the recorder/reproducer 151, as mentioned above. The still image file 300 includes a header section 301, a metadata section 302, and a compressed data section 303. The header section 301 includes an identification code indicating that the file has a still image file format, and the like. Further, the compressed data section 303 stores still image compressed data subjected to high-efficiency encoding.

The metadata section 302 records file name information 304 of the RAW file generated simultaneously with the still image file, and development status information 305 indicating that the still image file has been subjected to simple development by the simple developer 111. Further, the metadata section 302 records photographing metadata 306 including the aforementioned evaluation values and object information, and photographing information (e.g. lens type identification information and sensor type identification information).

Although not shown, the metadata section 302 may be configured to further record an identification code of the recording medium having the RAW file recorded thereon and path information of a folder in which the RAW file is recorded.

Next, referring to FIG. 3B, the RAW file 310 will be described. The RAW file 310 is recorded in a predetermined recording area of the recording medium 152 by the recorder/reproducer 151, as described hereinabove. The RAW file 310 includes a header section 311, a metadata section 312, and a compressed data section 313. The header section 311 records an identification code indicating that the file has a RAW file format, and so forth. The compressed data section 313 records RAW compressed data subjected to high-efficiency encoding (RAW image data can be recorded without being compressed, as mentioned hereinabove).

The metadata section 312 records file name information 314 of the still image file generated simultaneously with the RAW file and development status information 315 indicating that the still image file has been subjected to simple development by the simple developer 111. Further, the metadata section 312 records photographing metadata 316 having the above-described evaluation values and object information, and photographing information (e.g. lens type identification information and sensor type identification information).

Although not shown, the metadata section 312 may be configured to record an identification code of the recording medium having the still image file generated simultaneously with the RAW file recorded thereon, and path information of a folder in which the still image file is recorded. Alternatively, the still image file itself, which is generated simultaneously with the RAW file, may be converted to metadata and the metadata may be stored in the metadata section 312. The above-described structures of the still image file and the RAW file are given, only by way of example, and the still image file and the RAW file may have structures compliant with the standard of DCF (Design Rule for Camera File system) or Exif (Exchangeable image file format).

As described above, during the photographing mode-time process, the camera 100 performs the live view display before the photographing instruction is given according to the first image data acquired by the simple developer 111, and after the photographing instruction has been given, performs the development processing for acquiring the still image file using the simple developer 111.

On the other hand, as described hereinabove, the camera 100a generates a RAW file according to a photographing instruction. Although this RAW file is a high-quality file in which integrity of RAW image data as an output from the sensor signal processor 103 is not lost, the development processing is not required for generating the RAW file.

Therefore, the camera 100 can record a RAW file using a small-sized circuit with reduced power consumption, while increasing the number of pixels of an image and the speed of consecutive photographing.

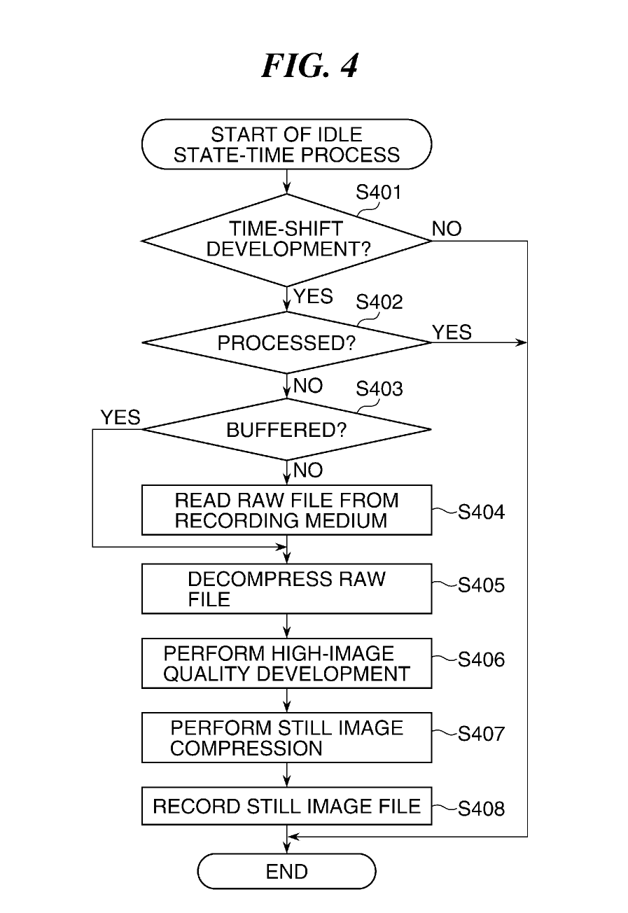

FIG. 4 is a flowchart of an idle state-time process performed by the camera shown in FIG. 1 in an idle state in which photographing is not performed. Note that the illustrated idle state-time process is executed under the control of the controller 161. More specifically, a program stored in the aforementioned ROM is loaded into the aforementioned RAM, and the CPU executes the loaded program.

When the idle state-time process is started, the controller 161 determines according to user's settings whether or not to perform time-shift development (step S401). If it is set not to perform time-shift development (NO to the step S401), the controller 161 terminates the idle state-time process.

Note that when time-shift development is not performed, the controller 161 shifts to one of the photographing mode and a reproduction mode, according to a mode setting (also referred to as the “mode selection”) by the user. Further, the above-mentioned term “time-shift development” refers to a process for generating a high-image quality display image and a high-quality still image file by performing high-image quality development processing on RAW image data using a RAW file recorded in the buffer 115 or the recording medium 152, as a source, after termination of a photographing operation.

As described above, the still image file generated by photographing is developed by the simple developer 111, and hence not only the number of pixels is limited but also part of the development processing is omitted. This causes the still image file generated by photographing to be limited in image quality.

Although an image acquired by the simple developer 111 has no problem in roughly checking photographic contents (a composition, an object, etc.) of the image, the image is sometimes not sufficient for checking the details thereof or printing out the same. On the other hand, the RAW file generated simultaneously with the still image file has a quality high enough to prevent integrity of the RAW image data from being lost, but cannot immediately comply with display and printout in real time since it is image data which has not been developed yet. That is, it takes time to perform RAW development processing on RAW files. Further, the RAW files are not of a widely used popular type, such as JPEG files, and hence an environment under which the RAW files can be handled is limited.

For this reason, in this example, when executing the time-shift development, the RAW file is read out by the recorder/reproducer 151, and the high-image quality development processing is performed on the RAW file by the high-image quality developer 112. The still image compressor 141 records a still image file acquired by compressing an output from the high-image quality developer 112, on the recording medium 152.

In the illustrated example, the above-described time-shift development is executed in a state in which processing load on the camera 100 is relatively small, which is a state in which a user's operation is awaited, including between photographing operations, the reproduction mode, and a sleep state. Note that the triggering of execution of the time-shift development is not limited to a user's operation but the time-shift development may be automatically executed by the controller 161.

By executing time-shift development as described above, it is possible to perform reproduction of an image while suppressing an increase in processing load, even when the request for high-quality image reproduction, such as the display for checking details and printout of an image thereof, is made.

As described hereinabove, the recording medium 152 records a pair of a still image file and a RAW file per one photographing instruction. When the time-shift development is to be manually or automatically executed (YES to the step S401), the controller 161 determines whether or not the pair of the still image file and the RAW file have been subjected to the time-shift development (step S402).

In the example illustrated in FIG. 4, the controller 161 determines whether or not the time-shift development has been performed, by referring to the development status information 305 recorded in the metadata section 302 shown in FIG. 3A. For example, the development status information 305 records a flag for identifying which of the simple developer 111 and the high-image quality developer 112 has processed the still image file, and by referring to the flag, when the flag indicates that the still image file has been processed by the simple developer 111, the controller 161 determines that the time-shift development has not been performed.

Note that the controller 161 may determine whether or not the time-shift development has not been performed, by referring to the development status information 315 in the RAW file 310. Further, the controller 161 may determine whether or not the time-shift development has not been performed, by referring to a table file separately provided for indicating a developed state of a still image file acquired by photographing.

If it is determined that the time-shift development has been performed (YES to the step S402), the controller 161 terminates the idle state-time process. On the other hand, if it is determined that the time-shift development has not been performed (NO to the step S402), the controller 161 determines whether or not the RAW file associated with the still image file which has not been subjected to the time-shift development is buffered in the buffer 115 (step S403).

If the RAW file is not buffered in the buffer 115 (NO to the step S403), the recorder/reproducer 151 under the control of the controller 161 reads out the RAW file associated with the still image file from the recording medium 152, and stores the RAW file in the buffer 115 (step S404).

Note that in a still image photographing mode, RAW image data items (compressed) are stored by giving a higher priority to a newer data item. In other words, the buffer 115 deletes RAW image data items, starting from the oldest ones. This makes it possible to always store the newest RAW image data items in the buffer 115, so that there is a very high possibility of the step S404 being skipped, whereby it is possible to perform high-speed development processing. Further, if RAW image data items are subjected to the time-shift development, starting from the newest ones, it is possible to preferentially develop the RAW image data items stored in the buffer 115, which makes it possible to efficiently perform the development processing.

Then, the RAW decompressor 114 performs the decompression processing on the RAW file stored in the buffer 115, to thereby restore RAW image data (decompressed RAW image data) (step S405). Note that when the RAW file is buffered (YES to the step S403), the controller 161 proceeds to the step S405 wherein the RAW decompressor 114 is controlled.

The decompressed RAW image data is sent to the high-image quality developer 112 via the switch section 121. The high-image quality developer 112 performs the high-image quality development processing on the decompressed RAW image data, and outputs the RAW image data as second image data (step S406). This second image data is sent to the display processor 124 and the still image compressor 141 via the switch section 123.

The high-image quality developer 112 performs the de-Bayer processing (de-mosaic processing) on the RAW image data, to thereby convert the RAW image data to mage data formed of a luminance component and a chrominance component. Then, the high-image quality developer 112 performs so-called development processing, such as processing for eliminating noise contained in the image data, and processing for correcting optical distortion. The image size (number of pixels) of image data generated by the high-image quality developer 112 is an image size of the output from the image pickup sensor 102 or an image size designated by the user, and has a higher quality than image data acquired by the simple development.

As described above, development performed by the high-image quality developer 112 is more accurate than development performed by the simple developer 111, which makes it possible to acquire high-quality image data, but results in an increase in processing load. Therefore, in the illustrated example, the high-image quality developer 112 avoids real-time development processing performed in parallel with photographing, to thereby reduce the circuit size and power consumption of the high-image quality developer 112.

Next, under the control of the controller 161, the still image compressor 141 performs high-efficiency encoding processing (still image compression) on the second image data, and generates a high-quality still image file (step S407). Then, the recorder/reproducer 151 records the high-quality still image file in the recording medium 152 (step S408). After recording by the recorder/reproducer 151, the controller 161 terminates the idle state-time process.

Note that the still image file recorded on the recording medium 152 in the step S408 has a file structure shown in FIG. 3A. The file name information 304 of a RAW file (original RAW file) as a source of the still image file is recorded in the metadata section 302. Further, the development status information 305 indicating that the still image file has been subjected to high-image quality development processing by the high-image quality developer 112 is recorded in the metadata section 302. Further, evaluation values, object information, and photographing information extracted from the metadata of the original RAW file are recorded in the photographing metadata 306.

To record the high-quality still image file, the recorder/reproducer 151 gives the same file name as that of a still image file developed by the simple development and recorded simultaneously with the original RAW file to the high-quality still image file, and writes the high-quality still image file over the still image file developed by the simple development. That is, the still image file developed by the simple development is deleted. Then, the recorder/reproducer 151 updates the development status information 315 of the metadata section 312 of the original RAW file using information indicating that the still image file has been subjected to the high-image quality development (or time-shift development).

As described above, in the camera 100 shown in FIG. 1, the time-shift development is executed in a state in which processing load is small, which is a state in which a user's operation is awaited, including between photographing operations, the reproduction mode, and a sleep state. Then, the still image file generated by developing by the simple development during photographing is replaced with a still image file having been subjected to the high-image quality development using the RAW file. Further, a moving image file generated by the simple development during photographing is also replaced with a moving image file having been subjected to the high-image quality development using the RAW file.

As a consequence, even when a request is received for display of an image for checking details thereof or for reproduction of a high-quality image, such as printout, it becomes unnecessary to perform development processing whenever such a request is received, thereby making it possible to reduce processing load and power consumption.

Next, a description will be given of a still image reproduction mode-time process performed by the camera 100 shown in FIG. 1.

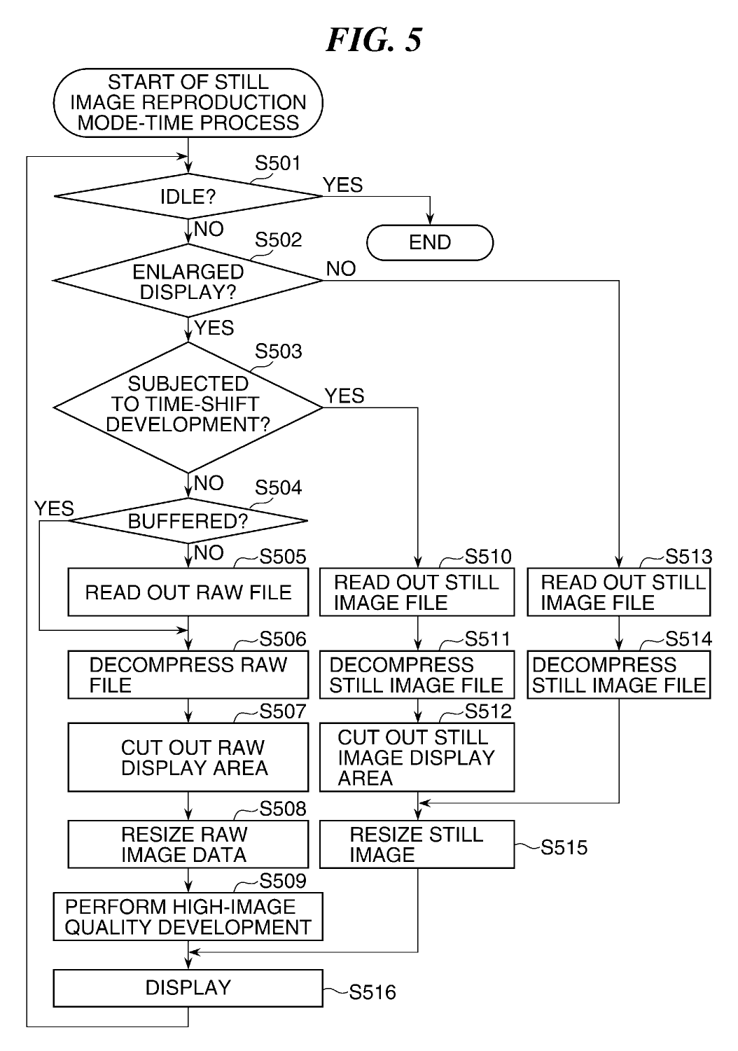

FIG. 5 is a flowchart of the still image reproduction mode-time process. Note that the illustrated still image reproduction mode-time process is executed under the control of the controller 161. More specifically, a program stored in the aforementioned ROM is loaded into the aforementioned RAM, and the CPU executes the loaded program.

When the still image reproduction mode-time process is started, the controller 161 determines whether or not the processing load of the camera 100 is low, that is, whether or not the camera 100 is in the idle state (step S501). If the camera 100 is in the idle state (YES to the step S501), the controller 161 terminates the still image reproduction mode-time process, and shifts to the above-described idle state-time process. For example, in the state in which the controller 161 is waiting for a user's operation, such as a reproduction instruction, the processing load is low, and hence the controller 161 terminates the still image reproduction mode-time process, and shifts to the above-described idle state-time process.

If the processing load on the camera 100 is high, that is, the camera 100 is not in the idle state (NO to the step S501), the controller 161 determines whether or not the user has instructed enlarged display of a still image file to be reproduced or being reproduced (hereafter referred to as the reproduction target still image file) (step S502). Note that the case where the camera 100 is not in the idle state refers to e.g. a case where reproduction of a still image has been started according to a user's operation (including a state performing still image reproduction).

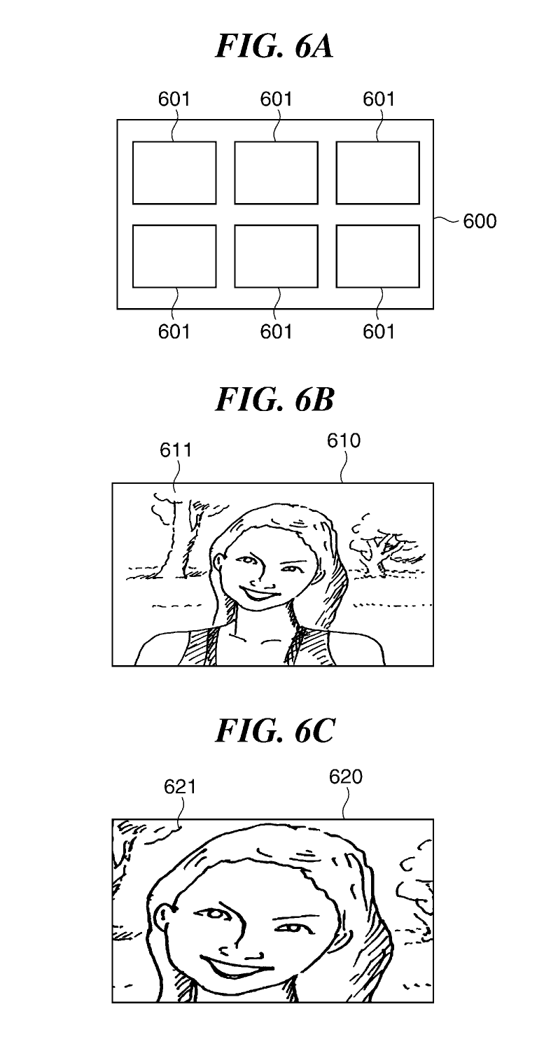

FIGS. 6A to 6C are diagrams useful in explaining an example of display processing in the still image reproduction mode-time process performed by the camera shown in FIG. 1, in which FIG. 6A shows an example of reduction display (thumbnail display), FIG. 6B shows a state in which one of thumbnail images shown in FIG. 6A is displayed on a whole display section, and FIG. 6C is an enlarged view of part of the image shown in FIG. 6B.

In the example illustrated in FIG. 6A, six images 601 having been subjected to reduction processing are displayed on a screen 600 displayed on the display section 125. That is, six thumbnail images 601 are displayed on the screen 600. When one of the six thumbnail images 601 is selected, an image 611 formed by expanding the selected thumbnail image 601 to a whole screen is displayed, as shown in FIG. 6B, on a screen 610. In this example, the state shown in FIG. 6B is referred to the “normal display”.

Further, in the normal display, when enlarged display of part of the image shown in FIG. 6B is instructed by a user's operation (enlarged display is instructed), as shown in FIG. 6C, an image 621 formed by enlarging part of the image displayed on the whole screen 610 (in the normal display) is displayed on a screen 620. The enlarged display shown in FIG. 6C is performed immediately after photographing in response to a user's operation so as to enable the user to check whether or not focusing is properly performed.

In high-image quality display, such as enlarged display, assuming an image displayed on the display section 125 is an image based on a still image file developed by the simple development, the number of pixels thereof sometimes becomes insufficient. That is, when an image is displayed using a still image file developed by the simple development, the resolution of the image is lowered.

Therefore, if an enlarged display instruction, which is given by the user's operation, has been received (YES to the step S502), the controller 161 determines whether or not the reproduction target still image file has been developed by the high-image quality developer 112. That is, the controller 161 determines whether or not the still image file has been subjected to the above-described time-shift development (step S503). To perform this determination, the controller 161 refers to the development status information 305 stored in the metadata section 302 of the still image file 300, as described hereinabove.

If the reproduction target still image file has not been subjected to the time-shift development (NO to the step S503), the controller 161 determines whether or not a RAW file associated with the reproduction target still image file has been buffered in the buffer 115 (step S504). If the RAW file has not been buffered in the buffer 115 (NO to the step S504), the recorder/reproducer 151 under the control of the controller 161 reads out the associated RAW file from the recording medium 152, and stores the same in the buffer 115 (step S505).

Next, the RAW decompressor 114 performs the decompression processing on the RAW file stored in the buffer 115 to restore RAW image data of the RAW file (decompressed RAW image data) (step S506). Then, under the control of the controller 161, the RAW decompressor 114 cuts out an enlarged display area (area to be subjected to enlarged display) of the decompressed RAW image data, designated by the enlarged display instruction, and acquires cut-out RAW image data (step S507).

Note that if the RAW file has been buffered (YES to the step S504), the controller 161 causes the RAW decompressor 114 to directly execute the step S506.

The cut-out RAW image data is sent to the resize processor 122 via the switch section 121. The resize processor 122 performs the resize processing on the cut-out RAW image data according to the screen size (e.g. the number of pixels) of the display section 125, and acquires RAW image data of a size suitable for display (resized RAW image data) (step S508).

Note that information on the screen size of the display section 125 is stored in advance in a memory (ROM, etc.) provided in the recording medium 152 or the resize processor 122.

Further, although, as described hereinabove, the time-shift development is not performed in parallel with photographing but performed by so-called distributed processing, when an enlarged display instruction is received in a state in which the still image file has not been subjected to the time-shift development, the RAW file is subjected to the high-image quality development. As a consequence, a delay occurs before the enlarged display is performed in response to the enlarged display instruction. To avoid this inconvenience, an amount of data required for the development processing is reduced by the resize processing in the step S508 to thereby reduce the display delay.

Next, the high-image quality developer 112 performs the high-image quality development processing on the resized RAW image data, and outputs the resized RAW image data as third image data (step S509). The third image data is sent to the display processor 124 via the switch section 123.

If the reproduction target still image file has been subjected to the time-shift development (YES to the step S503), the controller 161 determines that the still image file can be enlarged and displayed with sufficient image quality, and causes the recorder/reproducer 151 to read out the still image file from the recording medium 152 (step S510). Then, under the control of the controller 161, the still image decompressor 142 decodes and decompresses the still image file to acquire decompressed still image file (step S511).

Then, under the control of the controller 161, the display processor 124 cuts out an enlarged display area designated by the enlarged display instruction from the decompressed still image file, and acquires a cut-out still image file (step S512).

If an enlarged display instruction has not been input (NO to the step S502), i.e. if reduction display or 100% magnification display is performed, the controller 161 causes the recorder/reproducer 151 to read out a reproduction target still image file having been subjected to the simple development or the high-image quality development, from the recording medium 152 (step S513). Then, under the control of the controller 161, the still image decompressor 142 decodes and decompresses the still image file to acquire a decompressed still image file (step S514).

After execution of the step S512 or S514, the display processor 124 performs the resize processing on the cut-out still image file or the decompressed still image file, and generates a display image shown in FIG. 6A or 6B (step S515). Then, after execution of the step S509 or S515, the display processor 124 displays an image on the display section 125 (step S516). After execution of the step S516, the controller 161 returns to the step S501.

As described above, when an enlarged display instruction has been input, a high-quality image is displayed on the display section 125 under the control of the controller 161.

As described heretofore, in the first embodiment of the present invention, it is possible to selectively use an image file (i.e. image data) acquired by the simple development and image data acquired by the time-shift development, to thereby realize both of high-speed display and high-image quality display. When the high-image quality display is performed, if image data as the reproduction target has not been subjected to the time-shift development, the image data is resized to an image size suitable for display, and then is subjected to the high-image quality development processing. As a consequence, even when the high-image quality development processing is performed after receiving an instruction of the high-image quality display, it is possible to reduce the amount of data required for development processing without degrading the quality of an image, to thereby reduce display delay.

Next, a description will be given of an example of a camera as an image pickup apparatus including an image processing device according to a second embodiment of the present invention. Note that this camera has the same hardware configuration as that of the camera shown in FIG. 1, and hence description thereof is omitted.

In the above-described first embodiment, the description has been given of the case where in the reproduction mode, image data acquired by simple development processing and image data acquired by high-image quality development processing are switched for display on the display section 125, according to whether or not an enlarged display instruction has been received. In contrast, in the second embodiment, a description will be given of a case where image data acquired by the simple development processing and image data acquired by the high-image quality development processing are switched according to a screen size (number of pixels) of an external display device connected by the video output terminal 126, for display on the external display device.

Note that the second embodiment includes the processing described in the first embodiment and also processing in which the number of pixels of the external display device connected by the video output terminal 126 is acquired, and images to be displayed are switched according to the number of pixels. Description of the same processing as the processing in the first embodiment is briefly given.

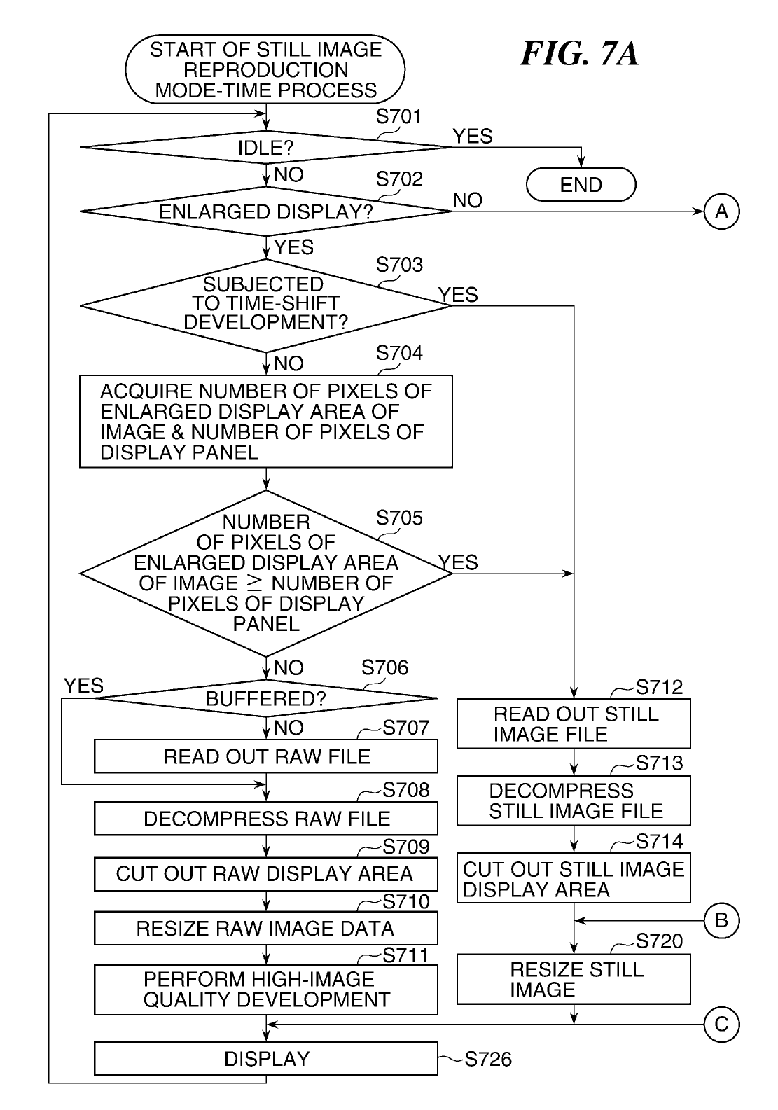

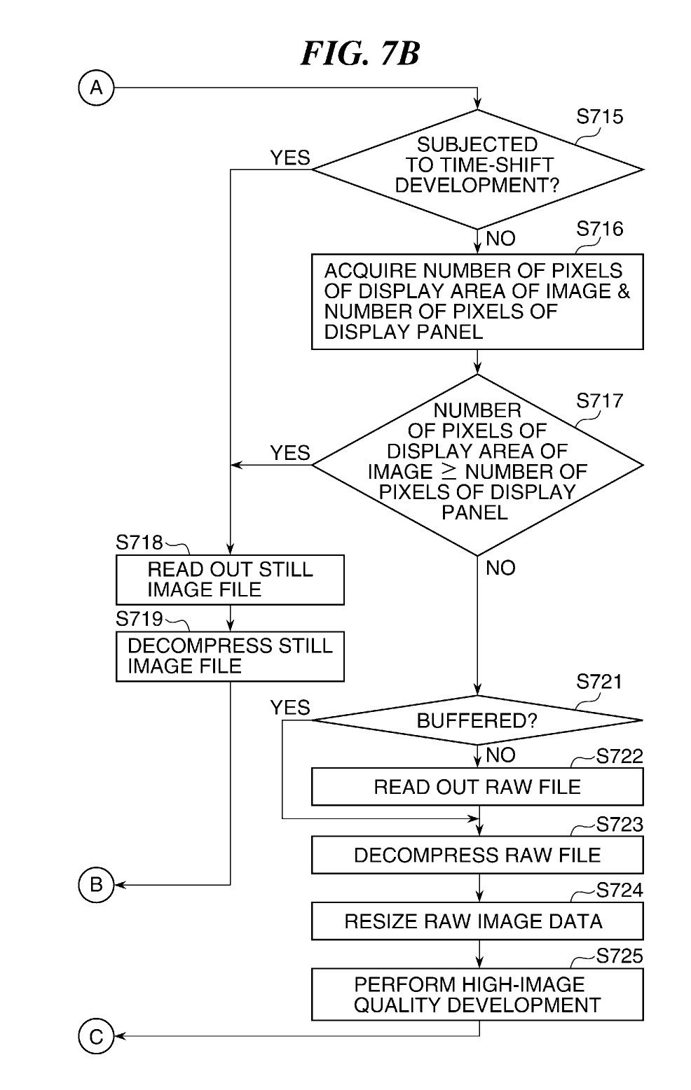

FIGS. 7A and 7B are a flowchart of a still image reproduction mode-time process performed by the camera as the image pickup apparatus including the image processing device according to the second embodiment. Note that the still image reproduction mode-time process shown in FIGS. 7A and 7B is executed under the control of the controller 161. More specifically, a program stored in the aforementioned ROM is loaded into the aforementioned RAM, and the CPU executes the loaded program.

When the still image reproduction mode-time process is started, the controller 161 determines whether or not the camera 100 is in the idle state (step S701). If the camera 100 is in the idle state (YES to the step S701), the controller 161 terminates the still image reproduction mode-time process, and shifts to the above-described idle state-time process.

If the camera 100 is not in the idle state (NO to the step S701), the controller 161 determines whether or not the user has input an enlarged display instruction of a still image file to be reproduced or being reproduced (step S702). If an enlarged display instruction by the user has been received (YES to the step S702), the controller 161 determines whether or not the reproduction target still image file has been subjected to the above-described time-shift development (step S703).

If the reproduction target still image file has not been subjected to the time-shift development (NO to the step S703), the controller 161 acquires the number of pixels of an enlarged display area of the reproduction target still image file, and acquires the number of display pixels of the external display device (not shown) connected by the video output terminal 126 (step S704). Then, the controller 161 determines whether or not the number of pixels of the enlarged display area of the reproduction target still image file is not smaller than the number of display pixels of the external display device (number of display panel pixels) (step S705).

Note that when the number of pixels of an enlarged display area of an image acquired by the simple development processing is larger than the number of pixels of the display device, the image acquired by the simple development processing can be displayed with sufficient image quality, so that it is possible to dispense with the high-image quality development processing in the display device. In other words, the enlarged display instruction alone is not enough to determine an optimum display image, and hence the optimum display image is determined by comparing the number of display pixels of the display device and the number of pixels of the enlarged display area.

If the number of pixels of the enlarged display area is smaller than the number of display panel pixels (NO to the step S705), the controller 161 determines whether or not a RAW file associated with the reproduction target still image file has been buffered in the buffer 115 (step S706). If the RAW file has not been buffered (NO to the step S706), the recorder/reproducer 151 under the control of the controller 161 reads out the RAW file associated with the still image file from the recording medium 152, and stores the RAW file in the buffer 115 (step S707).

Next, the RAW decompressor 114 performs decompression processing on the RAW file stored in the buffer 115, and restores RAW image data (decompressed RAW image data) (step S708). Then, under the control of the controller 161, the RAW decompressor 114 cuts out a display area (area to be subjected to enlarged display) of the decompressed RAW image data, designated by the enlarged display instruction, and acquires cut-out RAW image data (step S709).

Note that if the RAW file has been buffered (YES to the step S706), the controller 161 causes the RAW decompressor 114 to directly execute the step S708.

The cut-out RAW image data is sent to the resize processor 122 via the switch section 121. The resize processor 122 performs the resize processing on the cut-out RAW image data according to the screen size of the external display device connected to the video output terminal 126, and acquires RAW image data of a size suitable for display (resized RAW image data) (step S710).

Then, the high-image quality developer 112 performs the high-image quality development processing on the resized RAW image data, and outputs the resized RAW image data as the third image data (step S711). The third image data is sent to the display processor 124 via the switch section 123.

If the reproduction target still image file has been subjected to the time-shift development (YES to the step S703), or if the number of pixels of the enlarged display area of the reproduction target still image file is not smaller than the number of display panel pixels (YES to the step S705), the controller 161 causes the recorder/reproducer 151 to read out the still image file from the recording medium 152 (step S712). In the step S712, if the reproduction target still image file has been subjected to the time-shift development, image data generated by the high-image quality development processing is read out, whereas if the reproduction target still image file has not been subjected to the time-shift development, and if the number of pixels of the enlarged display area is not smaller than the number of display panel pixels, image data acquired by the simple development processing is read. Then, under the control of the controller 161, the still image decompressor 142 decodes and decompresses the still image file to acquire decompressed still image file (step S713).

Then, under the control of the controller 161, the display processor 124 cuts out an enlarged display area designated by the enlarged display instruction from the decompressed still image file to acquire a cut-out still image file (step S714).

If the enlarged display instruction has not been input by the user (NO to the step S702), the controller 161 determines whether or not the reproduction target still image file has been subjected to the time-shift development (step S715). If the reproduction target still image file has not been subjected to the time-shift development (NO to the step S715), the controller 161 acquires the number of pixels of a display area of the reproduction target still image file, and acquires the number of display pixels (number of display panel pixels) of the external display device connected by the video output terminal 126 (step S716). Then, the controller 161 determines whether or not the number of pixels of the display area of the reproduction target still image file is not smaller than the number of display panel pixels) (step S717).

When the reproduction target still image file target is to be displayed at an equal magnification, if the number of pixels of the display area is smaller than the number of display pixels of the external display device, the image acquired by the simple development processing cannot be displayed with sufficient image quality by the external display device, so that it is necessary to perform the high-image quality development processing. That is, the enlarged display instruction is not enough to determine an optimum display image, and hence the optimum display image is determined by comparing the number of display pixels of the external display device and the number of pixels of the display area.

If the reproduction target still image file has been subjected to the time-shift development (YES to the step S715), or if the number of pixels of the display area of the reproduction target still image file is not smaller than the number of display panel pixels (YES to the step S717), the controller 161 controls the recorder/reproducer 151 to read out the still image file from the recording medium 152 (step S718). In the step S718, if the reproduction target still image file has been subjected to the time-shift development, image data generated by the high-image quality development processing is read out, whereas if the reproduction target still image file has not been subjected to the time-shift development, and if the number of pixels of the enlarged display area is not smaller than the number of display panel pixels, image data acquired by the simple development processing is read out. Then, under the control of the controller 161, the still image decompressor 142 decodes and decompresses the still image file to acquire a decompressed still image file (step S719).

After execution of the step S714 or S719, the display processor 124 under the control of the controller 161 performs the resize processing on the cut-out still image file or the decompressed still image file, and generates a display image suitable for the screen size (the number of pixels) of the external display device (step S720).

If the number of pixels of the display area is smaller than the number of display panel pixels (NO to the step S717), the controller 161 determines whether or not a RAW file associated with the reproduction target still image file has been buffered in the buffer 115 (step S721). If the RAW file has not been buffered (NO to the step S721), the recorder/reproducer 151 under the control of the controller 161 reads out the RAW file associated with the still image file from the recording medium 152, and stores the RAW file in the buffer 115 (step S722).

Next, the RAW decompressor 114 performs the decompression processing on the RAW file stored in the buffer 115 to restore RAW image data (decompressed RAW image data) (step S723). Note that if the RAW file has been buffered (YES to the step S721), the controller 161 causes the RAW decompressor 114 to directly execute the step S723.

The decompressed RAW image data is sent to the resize processor 122 via the switch section 121. The resize processor 122 performs the resize processing on the decompressed RAW image data according to the screen size of the external display device connected to the video output terminal 126 to acquires RAW image data of a size suitable for display (resized RAW image data) (step S724).

Then, the high-image quality developer 112 performs the high-image quality development processing on the resized RAW image data, and outputs the resized RAW image data as the third image data (step S725). The third image data is sent to the display processor 124 via the switch section 123.

After execution of the step S711, S720, or S725, under the control of the controller 161, the display processor 124 sends the still image data to the external display device via the video output terminal 126 to display an image on the external display device (step S726). After that, the controller 161 returns to the step S701.

As described above, in the second embodiment of the present invention, the number of display pixels of the external display device connected to the camera 100 and the number of pixels of a display area of a reproduction target still image file are compared, and according to a result of the comparison, image data having been subjected to the simple development processing and image data having been subjected to the high-image quality development processing are selectively switched and displayed. As a consequence, unnecessary high-image quality development processing is not performed, and further an image with a low resolution is not displayed on the external display device.

As described heretofore, in the embodiments of the preset invention, it is possible to prevent display delay and, what is more, display an image with high quality, while reducing processing load.

As is apparent from the above description, in the example illustrated in FIG. 1, the display section 125 functions as a display unit, the RAW decompressor 114 and the simple developer 111 function as a first generation unit, and the RAW decompressor 114 and the high-image quality developer 112 function as a second generation unit. Further, the recording medium 152 function as a storage unit, and the controller 161 and the display processor 124 function as a display control unit.

Note that in the illustrated example, at least the controller 161, the console section 162, the recording medium 152, the recorder/reproducer 151, the buffer 115, the RAW decompressor 114, the simple developer 111, the high-image quality developer 112, the resize processor 122, the still image decompressor 142, the display processor 124, and the display section 125 constitute the image processing device.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Patent Application No. 2013-212741 filed Oct. 10, 2013 which is hereby incorporated by reference herein in its entirety.

What is claimed is:

1. An image processing device comprising:
a display unit configured to display an image;
a first generation unit configured to generate a first developed image by developing a RAW image;
a second generation unit configured to generate a second developed image having a higher image quality than the first developed image by developing the RAW image depending on load on the image processing device;
a storage unit configured to be capable of storing the RAW image and the first and second developed images; and
a display control unit configured to control image display by said display unit,
wherein in a case where an instruction for enlarged display of the first developed image displayed on said display unit has been received,
if the second developed image is stored in said storage unit, said display control unit performs enlarged display of the second developed image,
whereas if the second developed image is not stored in said storage unit, said display control unit displays a developed image for display use which is generated by developing part of the RAW image in a manner suited to enlarged display and has a higher image quality than the first developed image.

2. The image processing device according to claim 1, wherein said second generation unit generates the second developed image during in an idle state of the image processing device.

3. The image processing device according to claim 1, wherein said second generation unit generates the developed image for display use by cutting out part of the RAW image, forming a resized RAW image by resizing the cut-out part of the RAW image according to the number of pixels of said display unit, and developing the resized RAW image.

4. The image processing device according to claim 1, further comprising a comparison unit configured to compare the number of pixels of said display unit and the number of pixels of an area, for enlarged display, of the first developed image,
wherein as a result of comparison by said comparison unit, in a case where the number of pixels of the area, for enlarged display, of the first developed image is larger, said second generation unit does not generate the developed image for display use.

5. The image processing device according to claim 4, wherein said display control unit performs enlarged display of the first developed image stored in said storage unit.

6. The image processing device according to claim 1, wherein development status information is included in an image file of the developed image stored in said storage unit, and
wherein it is determined based on the development status information whether or not the second developed image is stored in said storage unit.

7. An image pickup apparatus comprising:
an image pickup unit configured to pick up an image; and
an image processing device,
wherein said image processing device comprises:
a display unit configured to display an image;
a first generation unit configured to generate a first developed image by developing a RAW image;
a second generation unit configured to generate a second developed image having a higher image quality than the first developed image by developing the RAW image depending on load on the image processing device;
a storage unit configured to be capable of storing the RAW image and the first and second developed images; and
a display control unit configured to control image display by said display unit,
wherein in a case where an instruction for enlarged display of the first developed image displayed on said display unit has been received,
if the second developed image is stored in said storage unit, said display control unit performs enlarged display of the second developed image,
whereas if the second developed image is not stored in said storage unit, said display control unit displays a developed image for display use which is generated by developing part of the RAW image in a manner suited to enlarged display and has a higher image quality than the first developed image.

8. An image processing method, comprising:
generating a first developed image by developing a RAW image;
generating a second developed image having a higher image quality than the first developed image by developing the RAW image depending on load on an image processing device;
storing the RAW image and the first and second developed images;
performing enlarged display of the second developed image, in a case where an instruction for enlarged display of the first developed image displayed on said display unit has been received, if the second developed image is stored in said storage unit; and
displaying a developed image for display use which is generated by developing part of the RAW image in a manner suited to enlarged display and has a higher image quality than the first developed image, in the case where the instruction for enlarged display of the first developed image displayed on said display unit has been received, if the second developed image is not stored in said storage unit.
